(19) United States
(12) Patent Application Publication
(10) Pub. No.: US 2026/0160033 A1
(43) Pub. Date: Jun. 11, 2026

(54) Auto Height Control for Collection Arm of Leaf Vacuum

(71) Applicant: Bonnell Industries, Inc., Dixon, IL (US)

(72) Inventors: Jeffrey J. Schwank, Sterling, IL (US); Phillip J. Megli, Dixon, IL (US); Logan Wilson, North Aurora, IL (US); Sam Stade, Aurora, IL (US); Khaled Alramahi, Lisle, IL (US); Jason K. Grimes, Ashton, IL (US)

(73) Assignee: Bonnell Industries, Inc., Dixon, IL (US)

(21) Appl. No.: 19/410,760

(22) Filed: Dec. 5, 2025

Related U.S. Application Data
(60) Provisional application No. 63/728,547, filed on Dec. 5, 2024.
(60) Provisional application No. 63/798,403, filed on May 1, 2025.

(51) Int. Cl. E01H 1/08; A01G 20/47

(52) U.S. Cl. CPC E01H 1/0827; A01G 20/47; E01H 2001/0881

(57) ABSTRACT

An automatic height control system and method for a leaf vacuum collection hose nozzle are provided. At least one surface proximity sensor provides information to a controller indicating the height of the nozzle above the surface. The controller compares that information to a preset or user defined desired height and commands the leaf vacuum swing arm boom carrying the collection hose to raise or lower the nozzle to achieve the desired height. The surface detected by the sensor may be the top surface of the leaves to be collected or the ground on which the leaves are piled based on the type of sensor used. The controller coordinates the speed of sweep of the nozzle to ensure that the nozzle can be raised or lowered to avoid contacting upsloping ground or other taller structure and to avoid sustained operation at an inefficient height over down sloping ground.

### CROSS-REFERENCE TO RELATED PATENT APPLICATIONS

This patent application claims the benefit of U.S. Provisional Patent Application No. 63/728,547, filed Dec. 5, 2024, and U.S. Provisional Patent Application No. 63/798,403, filed May 1, 2025, the entire teachings and disclosure of which are incorporated herein by reference thereto.

### FIELD OF THE INVENTION

This invention generally relates to leaf vacuums, and more particularly to positioning control of the swing arm boom that carries the leaf collection vacuum hose.

### BACKGROUND OF THE INVENTION

Commercial leaf vacuums, such as Titan Leaf Solutions leaf vacuums available from the assignee of the instant application, are used by municipalities, park districts, etc. during Autumn to collect fallen leaves, pinecones, needles, and other seasonal debris. These commercial leaf vacuums may be provided on dedicated trailers that may be towed, supplied on dedicated truck chassis mount configurations, or may be configured for hook lift or roll-off applications to be carried on commercial trucks that enable other equipment to be used during other seasons of the year, e.g., hook lift or roll-off salt spreaders.

Because of the tremendous volume of debris that needs to be collected by these commercial leaf vacuums during each operational deployment, high horsepower engines typically ranging from 70 hp to 100 hp are used to drive large diameter fans to generate the vacuum force needed to perform their function quickly and efficiently. To accommodate such volume of leaf collection and to position the collection vacuum where the leaves are, a large diameter collection vacuum hose that is carried by swing arm boom is used. This boom is typically positioned by a hydraulic system under the control of an operator.

Typical swing arm booms enable the operator to control the position of the inlet of the vacuum hose about an arc that can vary by model, but often includes at least 90 degrees or more. While simpler single member booms only allow the operator to control movement of the inlet left or right along the perimeter of the arc, more complex multi-member booms allow the operator to position the inlet anywhere within the area of the arc. The operator is also able to control the height of the hose inlet to enable leaf collection from ditches, on hills, or on the other side of guardrails and fences over which the hose can be positioned. In most systems, the positioning of the swing arm boom left/right and up/down is controlled by left/right and forward/back movement of a joystick. In the more complex multi-member boom systems, a rocker switch or second joystick may be used to position the inlet farther/closer to the leaf vacuum.

Unfortunately, control of the vacuum collection hose inlet during the collection operation requires sophisticated controls and operator training and attention. Indeed, even in systems that only allow control of left/right and up/down using a single joystick, the operator can have trouble controlling the inlet height and swing at same time, depending on hydraulic system quality.

That is, with a single joystick control, if the operator wants to move the inlet to the right and down simultaneously, the operator will push the joystick right and forward. In order to control both functions at once, the system is required to use a compensated hydraulic valve. Unfortunately, because of the unlimited range of motion available with a joystick (anywhere within a full 360-degree circle), positioning of that joystick to provide the desired rate of movement in both directions, i.e., to achieve the desired rate of swing and the desired rate of lowering of the inlet, with a proportionally controlled hydraulic system is difficult at best.

With such a single joystick control of swing and height functions, if the operator begins to move the nozzle too fast left or right and seeks to correct same by moving the joystick in the opposite direction to slow the swing rate, any off plane movement of the joystick forward or back can easily cause unintended lowering or raising of the inlet and may drive the nozzle into the ground, tear up sod, damage the nozzle, hit obstructions, or raise the inlet above a desired height.

As a result of such complexity, operators may choose simply to position the inlet at a certain height off the ground and thereafter disable the height so that movement of the joystick will only effectuate movement of the inlet of the hose left/right to collect the leaves.

Such swing-only control may well decrease the efficiency of the collection operation. If the inlet is higher than necessary for the collection of the leaves, then much of the vacuum force is wasted by simply drawing in extra air without leaves. If the inlet is lower than the height of a pile of leaves, then the movement of the hose will knock over the pile and spread the leaves while collecting from within the pile. This will require further movement of the inlet by the operator in order to collect the displaced leaves, which increases the amount of time and effort required to collect that pile of leaves.

Still more troubling than a reduction in efficiency from such fixed height operation, however, is the fact that the operator cannot see what lies below the surface of the leaves. If the pile of leaves covers a rock, stump, curbing, or sits on a rise, moving the boom to position the inlet in the pile as discussed above may cause a collision with the unseen structure that could damage the hose inlet or the boom itself. Indeed, even if the structure is visible, damage may occur if the operator does not recognize the need to raise the inlet while moving the boom to a leaf collection point on higher ground, such as in a yard separated from the street by a curb. Alternatively, if the leaves cover a ditch, hole, depression, or downslope, collecting the leaves from the surface may well leave leaves filling the unseen void, which may lead to someone falling into that leaf-filled area.

What is needed, therefore, is a leaf vacuum collection hose position control system and method that adjusts the height of the inlet automatically to avoid damage and to increase efficiency and completeness of the collection process. Embodiments of the present invention provide such an automatic height control system and method for the collection arm of a leaf vacuum. These and other advantages of the invention, as well as additional inventive features, will be apparent from the description of the invention provided herein.

### BRIEF SUMMARY OF THE INVENTION

In view of the above, embodiments of the present invention provide a new and improved leaf vacuum collection hose position control system and method that adjusts the height of the inlet nozzle of the collection hose automatically to avoid damage and to increase efficiency and completeness of the collection process. More particularly, embodiments of the present invention provide a new and improved leaf vacuum collection hose position control system and method that varies the position, and in particular embodiments the height, of the leaf vacuum swing arm boom that carries the vacuum collection hose.

In one embodiment, the system and method control the swing arm boom to vary the height of the collection nozzle carried thereby so as to follow the ground contour while the operator manipulates movement of the swing arm boom left and right, and in another embodiment forward and back. In certain embodiments, the system and method are configured to follow the height contour in proximity to the collection nozzle, which takes regard of the height of a leaf pile on top of the ground, and which lowers the collection nozzle as the pile is collected. In other embodiments, the system and method are configured to follow the ground contour itself without regard of the height of a leaf pile on top of the ground. That is, in such an embodiment the sensor sees through the leaf pile, thereby allowing the nozzle to follow the bottom profile of the pile, rather than the top.

Embodiments of the present invention utilize sensors to determine the position of the collection nozzle relative to a surface. In certain embodiments, that surface is the leaf pile top surface, and the sensors are selected from ultrasonic, sonar, optical (including photoelectric, photocell, laser, charge-coupled devices, infrared), lidar, radar, and capacitive proximity sensors. In other embodiments that surface is the ground itself without regard for the leaves piled thereon, and the sensors are selected from lidar, radar, sonar, infrared, and capacitive discharge sensors. In still other embodiments, a combination of sensors are provided and are selectively utilized based on an operator choice of surface definition during operation.

In an embodiment, a sensor is positioned to detect proximity of the surface below the nozzle. In such an embodiment, the system and method will maintain a preset or user defined distance from the surface as the boom arm is lowered and/or during operation. In one embodiment wherein manual operator height control is available, the system and method may be set to assume automatic control the boom arm to prevent surface contact by the nozzle and/or provide a notification to the operator of the distance to the surface and/or an alarm before the surface is contacted.

In certain embodiments, a sensor is positioned to detect proximity of the surface in the direction of swing. In such embodiment, the system and method will maintain a preset or user defined distance from the approaching surface to prevent surface contact by the nozzle as the boom arm is swung left or right and during operation, e.g., as the entire leaf vacuum is moved while the boom arm is stationary with respect to the leaf vacuum, such as when the vehicle carrying or towing the leaf vacuum is driven.

In still further embodiments that are particularly well suited for use with multi-member boom arms, a sensor is positioned to detect proximity of the surface in the direction of extension/retraction. In such embodiments, the system and method will maintain a preset or user defined distance from the approaching surface to prevent surface contact by the nozzle as the multi-member boom arm is extended or retracted to position the nozzle farther or closer to the leaf vacuum during operation.

In certain embodiments the system and method provide a manual mode, an automatic mode, and/or an automatic mode with manual override to control the height of the nozzle above the surface. To engage the automatic height control mode, the operator would select the Auto height function on the boom arm control panel. The sensor or sensors depending on the embodiment provide surface proximity information to a feedback loop in the controller that operates to regulate a hydraulic valve to automatically raise/lower the boom to maintain the predetermined or operator set height above the surface and any perceived obstacles.

While in either of the automatic modes, the operator is still able to control movement of the boom left and right, and if the leaf vacuum has a multi-member boom arm, the extend and retract functionality. However, movement of the boom under operator control is limited in speed based on sensor functionality. That is, movement of the boom in any of the horizontal directions will be limited based on the height control speed at which the boom may be lifted or lowered to maintain the proper height above the surface.

The speed of vertical movement and rate of response to height changes of the surface are regulated by a damper/slew rate control in certain embodiments to prevent hopping and other underdamped oscillatory tendencies of the boom arm that may otherwise cause surface contact or pose a danger. In view of this damping of the height control, the override of the speed of the manual horizontal movement ensures that the nozzle is not run into an upsloping surface or other taller obstacle before the nozzle can be raised to avoid such, and is not operated inefficiently for an extended period to high above a down sloping surface or drop off until the nozzle can be lowered to maintain the desired, efficient operating height.

In another embodiment, the system and method provide fully automatic operation of both the height and the left/right sweep functionality. The sweep distance in each direction or in total may be predetermined or set by an operator. In certain embodiments, the sweep function may be controlled by the surface sensor information indicating that there are leaves remaining to be collected. In other embodiments, the system and method automatically control “micro” left/right sweep functionality but provides “macro” operator input to steer the nozzle to maintain the micro sweep over the center of the leaf pile.

In certain embodiments, the operator is able to override the system and method with normal joystick input, thereby disabling automatic height control, automatic sweep control, or both. In other embodiments, the system and method allow the operator to manually adjust the height, sweep, or both during operation without otherwise disabling the automatic control function.

In various embodiments, the system and method utilize one or more of the following sensors, of one type or more: Capacitive, Capacitive displacement sensor, Doppler effect (sensor based on doppler effect), Inductive, Magnetic, including magnetic proximity fuse, Optical, Photoelectric, Photocell (reflective), Laser rangefinder, Passive (such as charge-coupled devices), Passive thermal infrared, Radar, Reflection of ionizing radiation, Sonar (active or passive), Ultrasonic sensor, Fiber optics sensor, Hall effect sensor), down/forward looking, etc., Inertial Measuring Units (IMUs) that may include various sensors such as accelerometers, gyroscopes, magnetometer, and positioning sensors such as GPS (Global Positioning System) and ADR (Automotive Dead Reckoning). In certain embodiments particularly useful in environments that suffer from entrained debris, e.g., dust, between the sensor and surface, or when the surface has a low dielectric constant, e.g., when covered by certain liquids, radar-based sensors are used instead of or in addition to ultrasonic sensors.

In certain embodiments, a lidar sensor located on a leaf vacuum or a chassis configuration of a leaf vacuum proximate the swing arm boom senses the terrain, e.g., the top of the leaf pile or ground thereunder, detects changes in the terrain, and makes a map of the terrain. One or more Inertial Measuring Units (IMUs) may be located on the swing arm boom to sense and communicate to the controller how the swing boom arm is currently positioned. This permits the controller to calculate where the swing boom arm is in relation to the map being created from the lidar sensed data. The CAN bus network may be a J1939 CAN bus network.

The controller then calculates how high above the terrain the swing boom should be based on a radius around the nozzle of the vacuum hose by using the map and the IMUs together. The controller then calculates exactly how to bend each joint of the swing boom arm to achieve that desired height and then sends those bend-commands onto a CAN bus network moving the swing boom arm just as it would in manual mode via the joystick. Indeed, the hydraulic controller is not able to distinguish the difference between the signals received of the controller via input from the IMUs and those of the joystick.

Moreover, if the user of the leaf vacuum utilizes the joystick deadman (a safety feature that requires continuous operator input to keep a machine or system active), the controller gets overridden, and hand-controls resume immediately. Meanwhile, an on-screen display shows any alerts and lets the operator tweak the clearance height as needed.

In certain embodiments, the system and method provides for the leaf vacuum or the chassis configuration of a leaf vacuum to include one or more position sensors, for example, GPS (Global Positioning System) and ADR (Automotive Dead Reckoning). While only GPS or similar positioning sensor may be used, in certain embodiments, the GPS is present together with ADR. ADR is a sensor that can integrate data from various other sensors to calculate position. For example, it can use a wheel speed and direction combined with IMU data (for example gyroscopes and accelerometers), to estimate the position of the leaf vacuum or the chassis configuration of a leaf vacuum. This is particularly useful where the GPS signals may be weak or unavailable.

The data sensed by the GPS and/or ADR can be input to the controller to facilitate calculation of the location of the leaf vacuum or the chassis configuration of a leaf vacuum which in turn, can be used to determine the location of the swing arm boom relative to the terrain of interest, that is where the leaf collection is to occur. In certain embodiments where a map of the terrain is being made from the sensed data, for example from the sensed data of the lidar sensor, the GPS and/or ADR data can be used by the controller to assist in making the map of the terrain and thereby ensure greater reliability in the map and in turn in the distance above the terrain of the nozzle of the vacuum hose on the swing boom arm.

In an embodiment, a height control system for a leaf vacuum having a nozzle affixed to a collection end of a leaf collection vacuum hose carried by a swing arm boom, the leaf vacuum including a hydraulic system including a height adjust hydraulic cylinder coupled to the swing arm boom to raise and lower the swing arm boom, includes at least one sensor positioned to detect a position of the nozzle of the collection hose relative to a surface, and a controller operatively coupled to the at least one sensor to receive the position of the nozzle of the collection hose relative to the surface, and operatively coupled to the hydraulic system to command the height adjust hydraulic cylinder to raise and lower the swing arm boom to position the nozzle at a height above the surface.

In one embodiment, the surface is a leaf pile top surface, and the at least one sensor is one of an ultrasonic, sonar, optical, lidar, radar, or capacitive proximity sensor. Preferably, the optical sensor is one of a photoelectric, photocell, laser, charge-coupled devices, or infrared sensor. In another embodiment, the surface is the ground itself without regard for leaves piled thereon, and the at least one sensor is one of a lidar, radar, sonar, infrared, or capacitive discharge sensor.

In certain embodiments, the at least one sensor includes a combination of sensors including at least one ultrasonic, sonar, optical, radar, or capacitive proximity sensor and at least one lidar, radar, sonar, infrared, or capacitive discharge sensor. In such embodiments, the controller selectively utilizes one of the combination of sensors based on an operator input of surface definition to command the height adjust hydraulic cylinder to raise and lower the swing arm boom to position the nozzle at the height above the surface.

In other embodiments, the at least one sensor includes a plurality of sensors positioned to detect the position of the nozzle of the collection hose relative to the surface directly below the nozzle and in each direction of travel of the nozzle. In such embodiments, the controller is configured to command the height adjust hydraulic cylinder to raise and lower the swing arm boom to position the nozzle at the height above the surface directly below the nozzle and in the direction of travel of the nozzle when the nozzle is moving in the direction of travel. Preferably, the plurality of sensors includes at least one of a right movement sensor, a left movement sensor, an extension movement sensor, or a retraction movement sensor.

In an embodiment, the at least one sensor includes a lidar sensor positioned to detect changes in the height of the surface. In such an embodiment, the controller is configured to make a map of the changes in the height of the surface. In one such embodiment, the system also includes at least one inertial measuring unit (IMU) positioned on the swing arm boom and operably coupled to the controller. The controller is configured to determine a position of the swing arm boom based on input from the IMU relative to the map, and is further configured to command the height adjust hydraulic cylinder to raise and lower the swing arm boom to position the nozzle at a height above the surface based on the position of the swing arm boom relative to the map.

In certain embodiments, the controller is further configured to limit a horizontal movement rate of the swing arm boom based on a vertical movement rate of the swing arm boom to maintain the height of the nozzle above the surface based on changes in the height of the surface indicated on the map. In one embodiment, the system also includes at least a wheel speed sensor of the leaf vacuum that is operably coupled to the controller. In such embodiment, the controller is configured to determine the position of the swing arm boom based on input from the wheel speed sensor and the IMU relative to the map.

In an embodiment, the controller includes damper/slew rate control to regulate a speed of vertical movement and rate of response to height changes of the surface to prevent hopping and underdamped oscillations of the swing arm boom when commanding the hydraulic system to raise and lower the swing arm boom.

In one embodiment, the height above the surface is a predetermined height based on a radius around the nozzle. In an embodiment, the height above the surface is user defined.

In certain embodiments, the leaf vacuum includes an operator height control member, and the controller is operably coupled to the operator height control member. In such embodiments, the controller is configured to command the height adjust hydraulic cylinder to raise and lower the swing arm boom to position the nozzle based on an input from the operator height control member when operated by an operator instead of at the height detected by the at least one sensor.

In various embodiments, the at least one sensor includes at least one of a capacitive, capacitive displacement, Doppler effect, inductive, magnetic, magnetic proximity fuse, optical, photoelectric, photocell, laser rangefinder, passive charge-coupled, passive thermal infrared, radar, reflection of ionizing radiation, sonar, ultrasonic, fiber optics, hall effect, down/forward looking, inertial measuring units (IMUs), accelerometers, gyroscopes, magnetometer, and global positioning system (GPS) and automotive dead reckoning (ADR) sensor.

In an embodiment of the present invention, a method of automatically controlling a height of an inlet of a leaf vacuum collection hose to avoid damage caused by collision of the inlet with ground or other structures on which leaves are piled during a leaf collection process includes the steps of sensing a distance from the inlet of the leaf vacuum collection hose to a surface, and controlling a vertical position of the inlet of the leaf vacuum collection hose to maintain a predetermined height above the surface.

In one embodiment, the surface is a leaf pile top surface, and the step of sensing the distance from the inlet of the leaf vacuum collection hose to the surface includes the step of sensing the distance from the inlet of the leaf vacuum collection hose to the leaf pile top surface using at least one of a ultrasonic, sonar, optical, lidar, radar, or capacitive proximity sensor.

In another embodiment, the surface is the ground itself without regard for leaves piled thereon, and the step of sensing the distance from the inlet of the leaf vacuum collection hose to the surface includes the step of sensing the distance from the inlet of the leaf vacuum collection hose to the ground using at least one of a lidar, radar, sonar, infrared, or capacitive discharge sensor.

In an embodiment, the step of sensing the distance from the inlet of the leaf vacuum collection hose to the surface includes the step of detecting the position of the inlet of the leaf vacuum collection hose to the surface directly below the inlet and in each direction of travel of the inlet. In such an embodiment, the step of controlling the vertical position of the inlet of the leaf vacuum collection hose to maintain the predetermined height above the surface includes the step of raising and lowering the inlet to position the inlet at the height above the surface directly below the inlet and in the direction of travel of the inlet when the inlet is moving in the direction of travel.

In one embodiment, the method includes the steps of creating a map of changes in the height of the surface using a lidar sensor, and determining a position of the inlet relative to the map using at least one of a GPS sensor or IMU. In such embodiment, the step of controlling the vertical position of the inlet of the leaf vacuum collection hose to maintain the predetermined height above the surface includes the step of controlling the vertical position of the inlet of the leaf vacuum collection hose to maintain the predetermined height above the surface based on the position of the inlet relative to the map.

In one such embodiment, the step of controlling the vertical position of the inlet of the leaf vacuum collection hose to maintain the predetermined height above the surface based on the position of the inlet relative to the map includes the step of limiting a horizontal movement rate of the inlet based on a vertical movement rate of the inlet to maintain the height of the inlet above the surface based on changes in the height of the surface indicated on the map.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a pictorial schematic illustration of an embodiment of a trailered leaf vacuum constructed and operated in accordance with an embodiment of the system and method of the present invention;

FIG. 2 is a pictorial schematic illustration of an embodiment of a chassis mount leaf vacuum constructed and operated in accordance with an embodiment of the system and method of the present invention;

FIG. 3 is a simplified component schematic of an embodiment of the height control system of the present invention; and

FIG. 4 is a simplified component schematic of the embodiment of the height control system of FIG. 3 having a manual adjustment module included therewith; and

FIG. 5 is a simplified control flow diagram of an embodiment of the method of the present invention;

FIG. 6 is a pictorial schematic illustration of an embodiment of a leaf vacuum constructed and operated in accordance with an embodiment of the system and method of the present invention and including a lidar sensor and Inertial Measuring Units on a swing arm boom; and

FIG. 7 is a pictorial schematic illustration of the lidar installation location on the leaf vacuum of FIG. 6.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Turning now to the drawings, there are illustrated various embodiments of the present invention that reduce operator workload, increase efficiency, and minimize the possibility of damage to the leaf vacuum and environment from which leaves are collected by at least controlling the height of the collection hose nozzle. It should be noted, however, that such embodiments are provided by way of example, and not by way of limitation, and that the novel features of the present invention may find applicability in other operating environments and configurations that many benefit from the features and operating modes discussed in the following description. All rights to such alternative embodiments are therefore reserved.

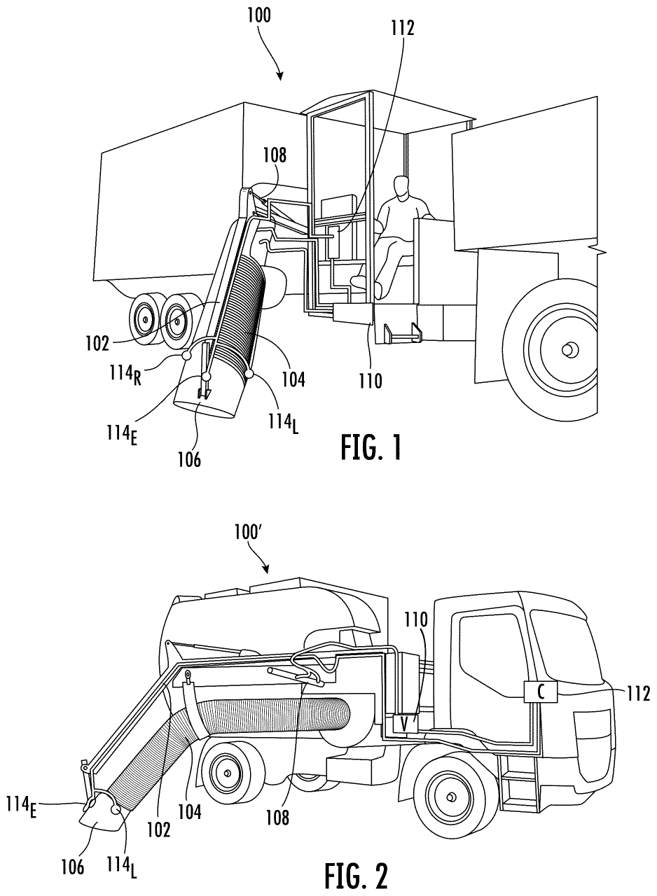

Turning then to FIG. 1, there is illustrated a leaf vacuum 100 constructed in accordance with the teachings of one embodiment of the present invention. The particular leaf vacuum 100 illustrated in FIG. 1 is a trailered configuration, although such implementation of the leaf vacuum 100 is not so limited to the motive configuration thereof. Indeed, FIG. 2, as will be discussed more fully below, illustrates a chassis configuration leaf vacuum 100′. Those skilled in the art will recognize other motive configurations may be used without departing from the scope of the present invention, and therefore are specifically reserved herein.

Returning again to FIG. 1, the leaf vacuum 100 includes a swing arm boom 102 that carries a leaf collection vacuum hose 104 having a nozzle 106 affixed to the collection end thereof. A height adjust hydraulic cylinder 108 is provided to raise and lower the swing arm boom 102, and therefore the leaf collection vacuum hose 104 and its nozzle 106 carried thereby. A hydraulic valve 110 is controlled by a controller 112 to vary the hydraulic pressure provided to the height adjust hydraulic cylinder 108 to vary the vertical position of the swing arm boom 102, and therefore the leaf collection vacuum hose 104 and its nozzle 106.

As discussed above, the controller 112 receives operator input to provide manual control of the positioning of the swing arm boom 102. Unlike prior systems, however, the controller 112 of this embodiment of the present invention also receives information from at least one proximity sensor 114 positioned to detect the surface in proximity to the nozzle 106. In the embodiment illustrated in FIG. 1, the swing arm boom 102 is a multi-member boom that allows the boom not only to be swung right and left, but also to be extended or retracted to position the nozzle 106 farther or closer to the side of the leaf vacuum 100. In such an embodiment, a proximity sensor is positioned to sense the surface not only below the nozzle, but also in each direction of travel enabled by the configuration of the swing arm boom 102 itself.

With the particular embodiment of FIG. 1, the system includes a right movement proximity sensor 114_{R}, a left movement proximity sensor 114_{L}, an extension movement proximity sensor 114_{E}, and a retraction movement proximity sensor (not shown). Each of these proximity sensors 114 are positioned to provide surface proximity information to the controller 112 so that the controller 112 can drive the hydraulic valve 110 to raise or lower the swing arm boom 102 via the height adjust hydraulic cylinder 108. This operation avoids nozzle 106 contact with the surface as the swing arm boom 102 is moved in any direction, under either operator or automatic control. The controller 112 will also vary the height of the swing arm boom 102 to ensure that an efficient collection of leaves is maintained by regulating the height of the nozzle 106 regardless of whether the surface slopes or transitions upward or downward relative to a previous position during the collection operation.

While the controller 112 will vary the height of the swing arm boom 102 to avoid surface contact of the nozzle 106 in the direction of movement of the swing arm boom 102, the controller 112 will also ensure that surface contact directly below the current position of the nozzle 106 is also avoided. For example, if the swing arm boom 102 is being swept towards a step change in height level of the surface, e.g., towards a curb or retention wall to a lower road or ground level, the controller 112 will prevent the lowering of the nozzle 106 until the curb or retention wall has been cleared so that contact with the higher surface is prevented, possibly at the expense of a reduced efficiency of collection for a short time until the nozzle 106 has cleared the step change in height.

The controller 112 will also prevent surface contact of the nozzle 106 in the situation that the swing arm boom 102 is being moved towards a steep incline or step change in height in the direction of travel. This is accomplished by the controller by reducing the rate of swing of the swing arm boom 102 in the direction of the incline or step change in surface height until the swing arm boom 102 can be raised to avoid such collisions in the direction of travel of the swing arm boom 102. Such operation of the controller 112 may override a manual input from the operator, or simply coordinate the automatic sweeping movement of the swing arm boom 102 under its automatic control.

While the system of FIG. 1 includes the advanced direction of travel proximity height control as just described, utilizing four proximity sensors noted above, more or fewer proximity sensors 114 may be used to provide additional or less direction of movement proximity detection and height control of the swing arm boom 102. Indeed, for single member swing arm booms (not shown), a single downward looking proximity sensor may be used to provide more limited collision avoidance functionality. However, depending on the selection of the particular type of proximity sensor 114, such an embodiment may still provide at least some measure of proximity detection in the direction of movement of the swing arm boom 102.

As introduced briefly above, FIG. 2 illustrates a leaf vacuum 100′in a chassis mount configuration wherein the operator controls not only the functionality of the leaf vacuum 100′ but also the operation of the truck on which the leaf vacuum 100′ is positioned. As with the embodiment illustrated in FIG. 1, the chassis mount leaf vacuum 100′ also utilizes a multimember swing arm boom 102 that allows for advanced motion control right and left, out and back, as well as up and down. Of course, those skilled in the art will recognize that a single member swing arm boom may be utilized that only provides motion right and left as well as height control up and down.

Despite the different configuration of the chassis mount leaf vacuum 100′ of FIG. 2 compared to the trailered leaf vacuum 100 FIG. 1, the controller 112 still receives input from the proximity sensors 114 and still controls the hydraulic valve 110 to drive the height adjust hydraulic cylinder 108 to raise and lower the swing arm boom 102 that carries the leaf collection vacuum hose 104 having the nozzle 106 positioned at the end thereof.

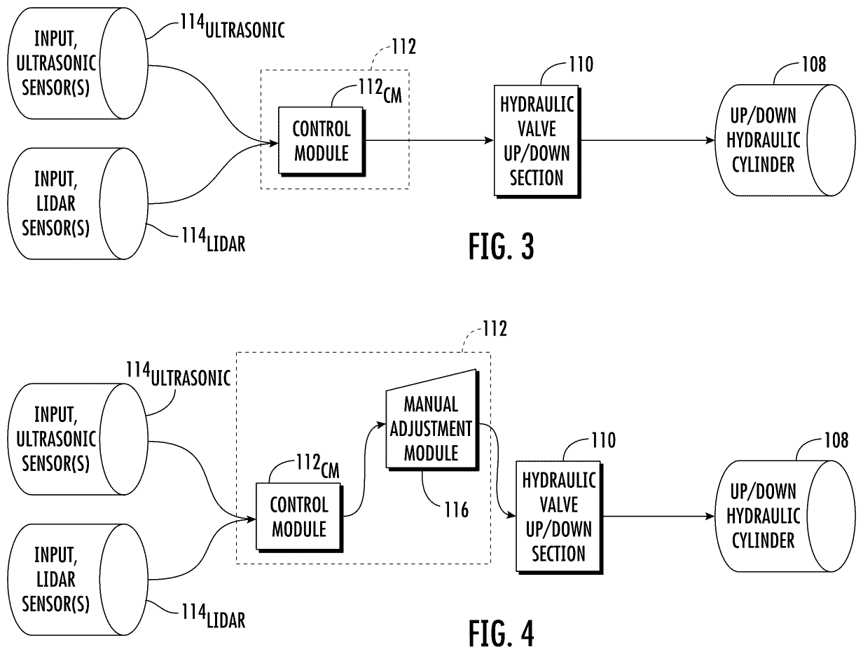

As illustrated in the simplified component schematic of FIG. 3, the controller 112 includes a control module 112_{CM} that receives input from the proximity sensors 114 illustrated in this FIG. 3 as an ultrasonic sensor 114_{ULTRASONIC} and a lidar sensor 114_{LIDAR}. As discussed above, the number of proximity sensors may vary based upon the sophistication desired of the system. However, this FIG. 3 now introduces an additional level of sophistication in this embodiment whereby different technology proximity sensors may be used, singly or in combination, at each or any of the positions relative to the nozzle.

For example, each of the proximity sensor locations discussed above can include the two proximity sensors 114_{ULTRASONIC} and 114_{LIDAR}. In doing so, the user is able to select with which surface the height of the nozzle 106 will be controlled to avoid collision.

For example, if the user selects the proximity sensor 114_{ULTRASONIC}, the height control effectuated by the control module 112_{CM} will position the nozzle above the upper surface of the leaf pile and will lower the height of the nozzle as the leaves are collected and the upper surface of the leaf pile diminishes. However, if the user were to select the proximity sensor 114_{LIDAR}, the height control in control module 112_{CM} will adjust the height of the nozzle so as to follow the ground contour on which the leaf pile sits. That is, by using different technology proximity sensors at each or any position around the nozzle 106 will allow the operator to select different modes of collection operation at the operator's preference.

In other embodiments, the different technology sensors may be positioned so as to control the height of the nozzle at a default surface definition based on the direction of movement. In one embodiment, for example, ultrasonic proximity sensors 114_{ULTRASONIC} may be used for the extension movement proximity sensor 114_{E} and the retraction movement proximity sensor (not shown) of FIGS. 1 and 2 so as not to disturb a leaf pile while positioning the nozzle 106 farther or closer to the side of the leaf vacuum 100. Such embodiment may use the lidar proximity sensor 114_{LIDAR} in the position of the right movement proximity sensor 114_{R} and the left movement proximity sensor 114_{L} to follow the ground contour while actually performing the sweeping movement of the swing arm boom 102 during collection operations.

Indeed, other embodiments of the present invention utilize different technology proximity sensors for each or a combination of the different movement axes. Such choice in these embodiments may take into account, e.g., the more limited operator view of the surface while swinging the swing arm boom 102 to the right based on operator position for the particular the leaf vacuum 100 or 100′. In such an embodiment, an ultrasonic proximity sensor 114_{ULTRASONIC} may be used in the position of the right movement proximity sensor 114_{R} while a lidar proximity sensor 114_{LIDAR} may be used in the left movement proximity sensor 114_{L} position.

In certain embodiments, a manual adjustment module 116 such as shown in FIG. 4 may be included as part of the controller 112 to allow the operator to manually adjust the height above which the nozzle 106 is controlled without disengaging the automatic height control mode of operation. Such manual adjustment may be desirable if the operator notices that a particular leaf pile is, e.g., wetter than other leaves currently being collected such that the nozzle 106 should be lowered closer to the surface thereof in order to effectively collect such heavier, wet leaves.

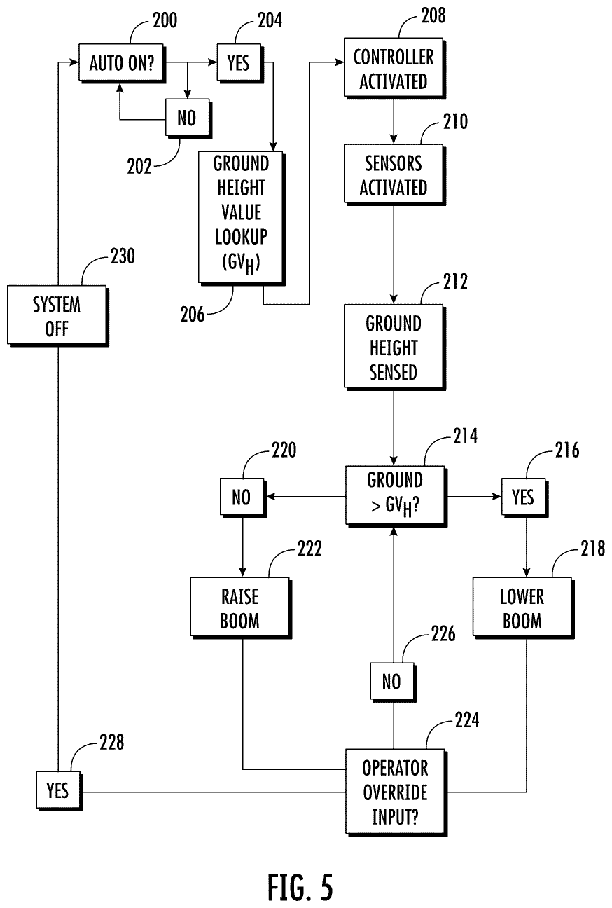

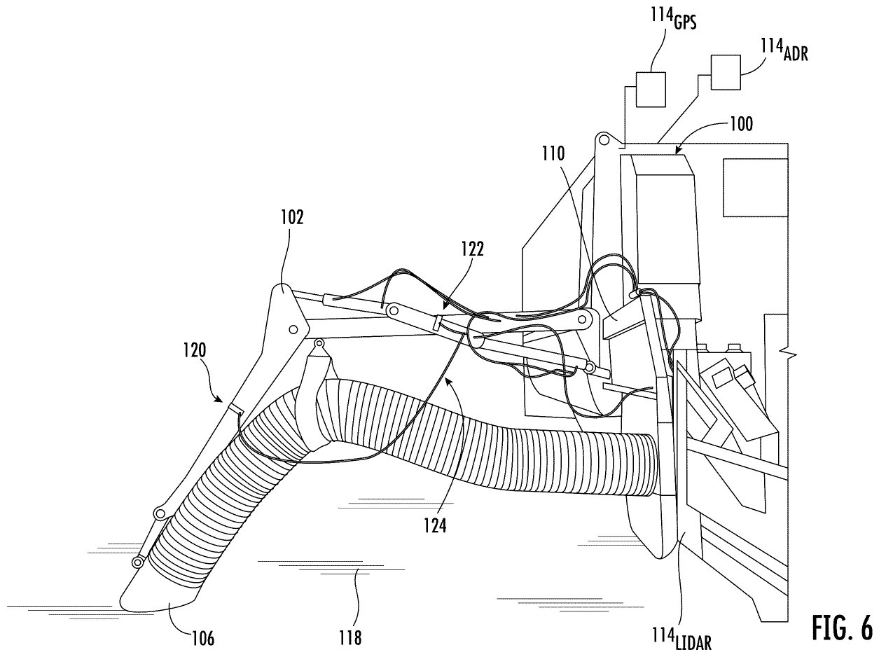

In order to effectuate the height control, the controller in one embodiment executes the method illustrated in the simplified control flow diagram of FIG. 5 to which attention is now directed.

At any point before or during operation of the leaf vacuum, the operator may engage the auto height control system. The controller monitors this input to determine whether the automatic function has been turned on at step 200. If not (step 202), the controller simply continues to monitor for such initiation and operates the leaf vacuum in accordance with the manual inputs from the operator.

However, if it is determined that the operator has initiated the auto height control system at step 204, the controller obtains the ground height value (GV_{H}) at step 206. This value may be stored in a lookup table or other memory location within the controller. In certain embodiments, the user has the ability to input this ground height value based on their operational preferences. Indeed, in certain embodiments as discussed above with regard to FIG. 4, the ground height value may be adjusted slightly based upon the manual adjustment input from the user during operation as discussed above.

Regardless of the mechanism for looking up, setting, or adjusting the ground height value at step 206, this value is used as the auto height controller is activated in step 208. Once the auto height function has been activated in the controller, the proximity sensors are activated at step 210 in order to allow the controller to sense the ground at step 212.

The controller then compares the sensed ground height from step 212 with the ground height value from step 206 to determine at step 214 whether the ground height is greater than the ground height value. As should be recognized by those skilled in the art, both the ground height value and the sensed ground height refer to the distance from the surface to the nozzle, and not some altimeter reading of the actual ground height itself.

When the height of the nozzle is greater than the ground height value as determined at step 216, the controller then issues the command to lower the swing arm boom at step 218. If the height of the nozzle above the ground is not greater than the ground height value as determined at step 220, then the controller issues the command to raise the swing arm boom at step 222.

This adjustment of the swing arm boom height may be overridden by operator input at step 224. However, if the operator has not overridden the automatic control as determined at step 226, then the comparison of the sensed nozzle height to the ground height value continues at step 214.

However, if the controller receives an operator override input as determined at step 228, then the controller turns off the auto height adjustment control system at step 230. Thereafter, the controller continues to monitor the operator input to determine whether the auto height control functionality is again engaged at step 200.

Turning to FIG. 6, the leaf vacuum 100 is shown having a lidar sensor 114_{LIDAR} located on a leaf vacuum 100 proximate the swing arm boom 102. The lidar sensor 114_{LIDAR} senses the terrain 118, detects changes in the terrain 118, and makes a map of the terrain 118. One or more Inertial Measuring Units (IMUs) 120, 122 may be located on the swing arm boom 102 to sense and communicate to the controller 112 (FIG. 1) how the swing boom arm 102 is currently bent. The IMUs are also able to sense and communicate the angular velocity of that portion of the swing boom arm 102 to which it is attached. This permits the controller 112 (FIG. 1) to calculate the orientation of the swing boom arm 102 and where the swing boom arm 102 is in relation to the map being created from the data collected from the lidar sensor 114_{LIDAR}.

The controller 112 then calculates how high above the terrain 118 the swing boom arm 102 should be based on a radius around the nozzle 106 of the vacuum hose 104 (FIG. 1) by using the map and the IMUs 120, 122 together. The controller 112 (FIG. 1) then calculates exactly how to bend each joint of the swing boom arm 102 to achieve that desired height above the terrain 118 and then sends those bend-commands onto a CAN bus network 124 moving the swing boom arm 102 just as it would in manual mode via a joystick of the manual adjustment module 116 (FIG. 4). Indeed, the hydraulic valve 110 is not able to distinguish the difference between the signals received of the controller 112 (FIG. 1) via input from the IMUs 120, 122 and those of the joystick of the manual adjustment module 116 (FIG. 4). In an embodiment, the CAN bus network may be a J1939 CAN bus network.

Moreover, if the user, that is the human operator, of the leaf vacuum 100 utilizes the joystick deadman (a safety feature that requires continuous operator input to keep a machine or system active) of the manual adjustment module 116 (FIG. 4), the controller 112 gets overridden, and hand-controls resume immediately. Meanwhile, an on-screen display (not illustrated) shows any alerts and lets the operator tweak the clearance height as needed.

The leaf vacuum 100 in the embodiment illustrated includes both a GPS sensor 114_{GPS} and ADR sensor 114_{ADR.} The data sensed by GPS sensor 114_{GPS} and ADR sensor 114_{ADR} can be input to the controller 112 (FIG. 1) to facilitate calculation of the location of the leaf vacuum 100 which in turn can be used to determine the location of the swing arm boom arm 102 relative to the terrain 118 where the leaf collection is to occur. The data sensed by GPS sensor 114_{GPS} and ADR sensor 114_{ADR} can be input to the controller 112 (FIG. 1) together with that of the lidar sensor 114_{LIDAR} to assist in creating the map of the terrain 118 and thereby assist in the calculation of the distance above ground or the leaf pile of the nozzle 106 on the swing arm boom 102.

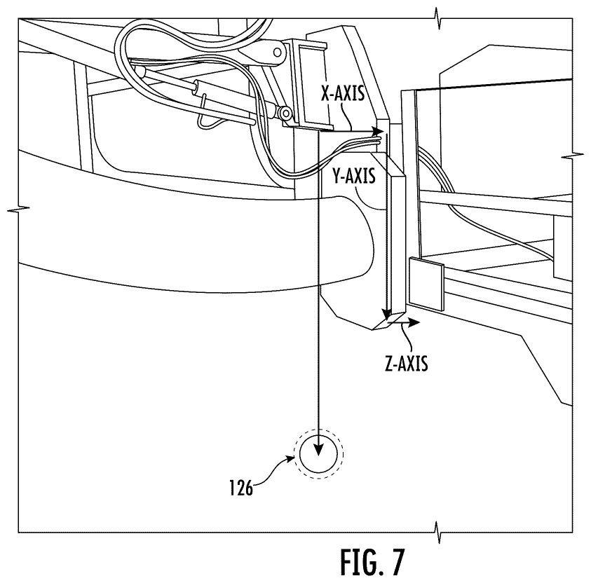

FIG. 7 illustrates the location of a Base_Link 126 centered about the Y-axis pivot that works with the lidar sensor 114_{LIDAR}. The Base_Link 126 serves as a reference point and is used for describing orientations, for example of the swing arm boom 102 relative to the reference point and in turn the map created from the sensed lidar data.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A height control system for a leaf vacuum having a nozzle affixed to a collection end of a leaf collection vacuum hose carried by a swing arm boom, the leaf vacuum including a hydraulic system including a height adjust hydraulic cylinder coupled to the swing arm boom to raise and lower the swing arm boom, comprising:
at least one sensor positioned to detect a position of the nozzle of the collection hose relative to a surface; and
a controller operatively coupled to the at least one sensor to receive the position of the nozzle of the collection hose relative to the surface, and operatively coupled to the hydraulic system to command the height adjust hydraulic cylinder to raise and lower the swing arm boom to position the nozzle at a height above the surface.

2. The system of claim 1, wherein the surface is a leaf pile top surface, and wherein the at least one sensor is one of an ultrasonic, sonar, optical, lidar, radar, or capacitive proximity sensor.

3. The system of claim 2, wherein the optical sensor is one of a photoelectric, photocell, laser, charge-coupled devices, or infrared sensor.

4. The system of claim 1, wherein the surface is ground itself without regard for leaves piled thereon, and wherein the at least one sensor is one of a lidar, radar, sonar, infrared, or capacitive discharge sensor.

5. The system of claim 1, wherein the at least one sensor includes a combination of sensors including at least one ultrasonic, sonar, optical, radar, or capacitive proximity sensor and at least one lidar, radar, sonar, infrared, or capacitive discharge sensor, and wherein the controller selectively utilizes one of the combination of sensors based on an operator input of surface definition to command the height adjust hydraulic cylinder to raise and lower the swing arm boom to position the nozzle at the height above the surface.

6. The system of claim 1, wherein the at least one sensor includes a plurality of sensors positioned to detect the position of the nozzle of the collection hose relative to the surface directly below the nozzle and in each direction of travel of the nozzle, and wherein the controller is configured to command the height adjust hydraulic cylinder to raise and lower the swing arm boom to position the nozzle at the height above the surface directly below the nozzle and in the direction of travel of the nozzle when the nozzle is moving in the direction of travel.

7. The system of claim 6, wherein the plurality of sensors includes at least one of a right movement sensor, a left movement sensor, an extension movement sensor, or a retraction movement sensor.

8. The system of claim 1, wherein the at least one sensor includes a lidar sensor positioned to detect changes in the height of the surface, and wherein the controller is configured to make a map of the changes in the height of the surface.

9. The system of claim 8, further comprising at least one inertial measuring unit (IMU) positioned on the swing arm boom and operably coupled to the controller, wherein the controller is configured to determine a position of the swing arm boom based on input from the IMU relative to the map, and wherein the controller is further configured to command the height adjust hydraulic cylinder to raise and lower the swing arm boom to position the nozzle at a height above the surface based on the position of the swing arm boom relative to the map.

10. The system of claim 9, wherein the controller is further configured to limit a horizontal movement rate of the swing arm boom based on a vertical movement rate of the swing arm boom to maintain the height of the nozzle above the surface based on changes in the height of the surface indicated on the map.

11. The system of claim 9, further comprising at least one wheel speed sensor of the leaf vacuum and operably coupled to the controller, and wherein the controller is configured to determine the position of the swing arm boom based on input from the wheel speed sensor and the IMU relative to the map.

12. The system of claim 1, wherein the controller includes damper/slew rate control to regulate a speed of vertical movement and rate of response to height changes of the surface to prevent hopping and underdamped oscillations of the swing arm boom when commanding the hydraulic system to raise and lower the swing arm boom.

13. The system of claim 1, wherein the height above the surface is a predetermined height based on a radius around the nozzle.

14. The system of claim 1, wherein the height above the surface is user defined.

15. The system of claim 1, wherein the leaf vacuum includes an operator height control member, wherein the controller is operably coupled to the operator height control member, and wherein the controller is configured to command the height adjust hydraulic cylinder to raise and lower the swing arm boom to position the nozzle based on an input from the operator height control member when operated by an operator instead of at the height detected by the at least one sensor.

16. The system of claim 1, wherein the at least one sensor includes at least one of a capacitive, capacitive displacement, Doppler effect, inductive, magnetic, magnetic proximity fuse, optical, photoelectric, photocell, laser rangefinder, passive charge-coupled, passive thermal infrared, radar, reflection of ionizing radiation, sonar, ultrasonic, fiber optics, hall effect, down/forward looking, inertial measuring units (IMUs), accelerometers, gyroscopes, magnetometer, and global positioning system (GPS) and automotive dead reckoning (ADR) sensor.

17. A method of automatically controlling a height of an inlet of a leaf vacuum collection hose to avoid damage caused by collision of the inlet with ground or other structures on which leaves are piled during a leaf collection process, the method comprising the steps of:
sensing a distance from the inlet of the leaf vacuum collection hose to a surface; and
controlling a vertical position of the inlet of the leaf vacuum collection hose to maintain a predetermined height above the surface.

18. The method of claim 17, wherein the surface is a leaf pile top surface, and wherein the step of sensing the distance from the inlet of the leaf vacuum collection hose to the surface comprises the step of sensing the distance from the inlet of the leaf vacuum collection hose to the leaf pile top surface using at least one of a ultrasonic, sonar, optical, lidar, radar, or capacitive proximity sensor.

19. The method of claim 17, wherein the surface is ground itself without regard for leaves piled thereon, and wherein the step of sensing the distance from the inlet of the leaf vacuum collection hose to the surface comprises the step of sensing the distance from the inlet of the leaf vacuum collection hose to the ground using at least one a lidar, radar, sonar, infrared, or capacitive discharge sensor.

20. The method of claim 17, wherein the step of sensing the distance from the inlet of the leaf vacuum collection hose to the surface comprises the step of detecting the position of the inlet of the leaf vacuum collection hose to the surface directly below the inlet and in each direction of travel of the inlet, and wherein the step of controlling the vertical position of the inlet of the leaf vacuum collection hose to maintain the predetermined height above the surface comprises the step of raising and lowering the inlet to position the inlet at the height above the surface directly below the inlet and in the direction of travel of the inlet when the inlet is moving in the direction of travel.

21. The method of claim 1, further comprising the steps of creating a map of changes in the height of the surface using a lidar sensor, determining a position of the inlet relative to the map using at least one of a GPS sensor or IMU, and wherein the step of controlling the vertical position of the inlet of the leaf vacuum collection hose to maintain the predetermined height above the surface comprises the step of controlling the vertical position of the inlet of the leaf vacuum collection hose to maintain the predetermined height above the surface based on the position of the inlet relative to the map.

22. The method of claim 21, wherein the step of controlling the vertical position of the inlet of the leaf vacuum collection hose to maintain the predetermined height above the surface based on the position of the inlet relative to the map comprises the step of limiting a horizontal movement rate of the inlet based on a vertical movement rate of the inlet to maintain the height of the inlet above the surface based on changes in the height of the surface indicated on the map.
